(19) United States
(12) Patent Application Publication
(10) Pub. No.: US 2024/0274320 A1
(43) Pub. Date: Aug. 15, 2024

(54) MULTICORE CABLE

(71) Applicant: SUMITOMO ELECTRIC INDUSTRIES, LTD., Osaka (JP)

(72) Inventors: Takaaki OKAMOTO, Tochigi (JP); Yuji OCHI, Tochigi (JP); Ryuuta FURUYASHIKI, Tochigi (JP)

(21) Appl. No.: 18/568,532

(22) PCT Filed: Jul. 20, 2022
(86) PCT No.: PCT/JP2022/028182

§ 371 Date: Dec. 8, 2023

(30) Foreign Application Priority Data
Jul. 21, 2021 (JP) 2021-120532

(51) Int. Cl. H01B 7/22; H01B 7/00; H01B 7/18

(52) U.S. Cl. CPC H01B 7/226; H01B 7/0009; H01B 7/1825

(57) ABSTRACT

A multicore cable has a core including a plurality of insulated wires, and an outer sheath covering an outer surface of the core, wherein the outer sheath includes a convex portion disposed between the insulated wires located on an outer peripheral side of the core and in contact with at least a portion of surfaces of the insulated wires.

### TECHNICAL FIELD

The present disclosure relates to multicore cables.

This application is based upon and claims priority to Japanese Patent Application No. 2021-120532 filed on Jul. 21, 2021, the entire contents of which are incorporated herein by reference.

### BACKGROUND ART

Patent Document 1 describes a multicore cable including a main wire, including a plurality of core wires and a covering portion covering the plurality of core wires, and a crimping tool attached to a boundary position between a curved portion that is generated when one end of the main wire is fixed in a horizontal position and a predetermined force is applied downward in a vertical direction to the other end of the main wire, and a straight portion extending in the vertical direction, and configured to crush the main wire so as crimp the covering portion and the plurality of core wires.

### PRIOR ART DOCUMENTS

### Patent Documents

Patent Document 1: Japanese Laid-Open Patent Publication No. 2016-178067

### DISCLOSURE OF THE INVENTION

A multicore cable according to the present disclosure includes a core including a plurality of insulated wires; and an outer sheath covering an outer surface of the core, wherein the outer sheath includes a convex portion disposed between the insulated wires located on an outer peripheral side of the core and in contact with at least a portion of surfaces of the insulated wires.

### BRIEF DESCRIPTION OF THE DRAWINGS

FIG. 1 is a cross sectional view of a multicore cable according to direction of a multicore cable according to one aspect of the present disclosure along a plane perpendicular to a longitudinal direction.

FIG. 2 illustrates another configuration example of the cross sectional view of the multicore cable according to one aspect of the present disclosure along the plane perpendicular to the longitudinal direction.

FIG. 3 illustrates another configuration example of the cross sectional view of the multicore cable according to one aspect of the present disclosure along the plane perpendicular to the longitudinal direction.

FIG. 4 illustrates another configuration example of the cross sectional view of the multicore cable according to one aspect of the present disclosure along the plane perpendicular to the longitudinal direction.

FIG. 5 illustrates another configuration example of the cross sectional view of the multicore cable according to one aspect of the present disclosure along the plane perpendicular to the longitudinal direction.

FIG. 6 is a diagram for explaining a noise test.

FIG. 7A is a photograph of a cross section of the multicore cable manufactured in an experimental example 1-1 along the plane perpendicular to the longitudinal direction.

FIG. 7B is a photograph of a cross section of the multicore cable manufactured in an experimental example 1-2 along the plane perpendicular to the longitudinal direction.

FIG. 7C is a photograph of a cross section of the multicore cable manufactured in an experimental example 1-3 along the plane perpendicular to the longitudinal direction.

### MODE OF CARRYING OUT THE INVENTION

### Problem to be Solved by the Present Disclosure

Conventionally, a multicore cable, having a plurality of insulated wires or the like aggregated and integrated therein, is used in various applications. For example, in an audio equipment, such as a headphone or an earphone, the multicore cable is used as a cable for connecting an electronic equipment or a plug to a headphone unit or the like which outputs sound.

When a force is applied to the multicore cable during use or the like of the equipment to which the multicore cable is connected, the multicore cable may be bent, and a rubbing sound may be generated from the multicore cable, thereby generating a noise. In a case where the equipment to be used is the audio equipment or the like, reduction of the noise generated when the multicore cable is bent is required in some cases.

Accordingly, it is one object of the present disclosure to provide a multicore cable which can reduce the noise when the multicore cable is bent.

### Effects of the Present Disclosure

According to the present disclosure, it is possible to provide a multicore cable which can reduce the noise when the multicore cable is bent.

### DESCRIPTION OF EMBODIMENTS OF THE PRESENT DISCLOSURE

First, embodiments of the present disclosure will be described in the following. In the following description, the same or corresponding elements are designated by the same reference numerals, and a redundant description thereof will be omitted.

(1) A multicore cable according to one aspect of the present disclosure includes a core including a plurality of insulated wires, and an outer sheath covering an outer surface of the core, wherein the outer sheath includes a convex portion disposed between the insulated wires located on an outer peripheral side of the core and in contact with at least a portion of surfaces of the insulated wires.

The present inventors studied the cause of the noise that is generated when the multicore cable is bent. It was regarded that, in a case where a multicore cable having a gap between a core and an outer sheath is bent, the core makes contact with the outer sheath, the core moves along an inner periphery of the outer sheath in a cross section perpendicular to a longitudinal direction of the multicore cable, and the core rubs against the outer sheath, thereby generating the noise.

Accordingly, the outer sheath of the multicore cable according to one aspect of the present disclosure may include the convex portion, disposed between the insulated wires located on the outer peripheral side of the core, and in contact with at least a portion of the surfaces of the insulated wires.

Because the outer sheath is disposed between the insulated wires located on the outer peripheral side of the core and has the convex portion in contact with at least a portion of the surfaces of the insulated wires, the outer sheath can be insered in the gap between the insulated wires located on the outer peripheral side of the core. For this reason, the convex portion functions as an anchor of the outer sheath, thereby reducing the noise generated when the core moves along the inner periphery of the outer sheath in the case where the multicore cable is bent and they rub each other. Accordingly, compared to a case where the outer sheath does not have the convex portion, it is possible to prevent the rubbing between the outer sheath and the core, and reduce the generation of the noise caused thereby.

(2) A height of the convex portion may be greater than or equal to 0.05 nm.

By setting the height of the convex portion to a value greater than or equal to 0.05 mm, it is possible to increase the effect of restricting the movement of the core when the multicore cable is bent, and particularly reduce the generation of the noise.

(3) The plurality of insulated wires may include a first insulated wire and a second insulated wire having an outer diameter larger than an outer diameter of the first insulated wire, and the second insulated wire may be disposed on an outer peripheral side of the core.

By disposing the second insulated wire having the larger outer diameter on the outer peripheral side of the core, it is possible to reduce the outer diameter of the core, and reduce a diameter of the multicore cable.

(4) The first insulated wire and the second insulated wire may be disposed on the outer peripheral side of the core, and in a cross section perpendicular to a longitudinal direction of the core, a first region including the first insulated wire and a second region including the second insulated wire may be alternately arranged along an outer periphery of the core.

By alternately arranging the first region including the first insulated wire and the second region including the second insulated wire along the outer periphery of the core, the second insulated wire having the larger outer diameter can be distributed on the outer periphery of the core. For this reason, the shape of the cross section perpendicular to the longitudinal direction of the core can be made close to a circular shape. In addition, it is possible to particularly increase the height of the convex portion disposed between the first insulated wire and the second insulated wire that are adjacent to each other, and particularly reduce the generation of the noise.

(5) The core may include a twisted pair insulated wire having two insulated wires twisted together.

By including the twisted pair insulated wire in the core, the multicore cable can be applied to a wider range of applications in addition, by including the twisted pair insulated wire in the core, it is possible to improve handleability when performing the wiring or the like.

(6) The insulated wire located on the outer peripheral side of the core may be in direct contact with the outer sheath.

By causing the insulated wire to be in direct contact with the outer sheath including the convex portion, both the insulated wire and the outer sheath are in close contact with each other. For this reason, in the case where the multicore cable is bent, it is possible to prevent the core from moving along the inner periphery of the outer sheath, and particularly reduce the generation of the noise.

(7) in a state where the multicore cable is bent, at least a portion of the insulated wire disposed on the outer peripheral side of the core and the convex portion may be in contact with each other at a bent portion.

When the multicore cable according to one aspect of the present disclosure is bent, the insulated wires located on the outer peripheral side of the core, and the convex portion, may be in contact in at least a portion thereof, thereby restricting the movement of the core along the inner periphery of the outer sheath when the multicore cable is bent. For this reason, it is possible to reduce the generation of the noise when the multicore cable is bent.

(8) The insulated wire may include a central conductor, and an insulator covering an outer surface of the central conductor, and the insulator may include a fluororesin.

In a case where the fluororesin is used for the insulator that forms an outer cover of the insulated wire, the core may easily move along the inner periphery of the outer sheath. However, in the multicore cable according to one aspect of the present disclosure, even in the case where the insulator is formed of the fluororesin, it is possible to restrict the movement of the core along the inner periphery of the outer sheath, and reduce the generation of the noise. For this reason, a particularly high effect of reducing the noise can be exhibited in the case where the fluororesin is used for the insulator of the insulated wire.

In addition, by using the fluororesin as a material used for the insulator, it is possible to reduce a thickness of the insulator, and reduce a diameter of the insulated wire or the entire multicore cable of the present embodiment including the insulated wire.

(9) The outer sheath may include a thermoplastic resin.

In a case where the outer sheath includes the thermoplastic resin, the convex portion can easily be formed between the insulated wires located on the outer peripheral side of the core.

(10) The core may have a gap between at least a pair of adjacent insulated wires among the plurality of insulated wires located on the outer peripheral side of the core.

By providing the gap between at least the pair of adjacent insulated wires among the plurality of insulated wires located on the outer peripheral side of the core, even in a case where the pair of insulated wires is displaced when the multicore cable is bent, it is possible to reduce a force applied to the pair of insulated wires so as to press against each other. For this reason, when the multicore cable is bent, it is possible to reduce the force applied to the convex portion disposed between the pair of insulated wires, to increase an anchor effect by the convex portion, and to reduce the generation of the noise.

(11) A void may be provided inside the core in a cross section perpendicular to a longitudinal direction.

By employing a configuration having the void inside the core, that is, the outer sheath does not penetrate into the inside the core, it is possible to reduce a force applied to the plurality of insulated wires included in the core when the multicore cable is bent. For this reason, even in the case where the multicore cable is bent repeatedly, it is possible to prevent breaking or the like of the plurality of insulated wires.

### DETAILS OF EMBODIMENTS OF THE PRESENT DISCLOSURE

Specific examples of the multicore cable according to one embodiment of the present disclosure (hereinafter referred to as “the present embodiment”) will be described below, with reference to the drawings. The present invention is not limited to these examples, and is intended to include all modifications within the meaning and scope of the present invention as defined in the claims and equivalents thereof.

### (Multicore Cable)

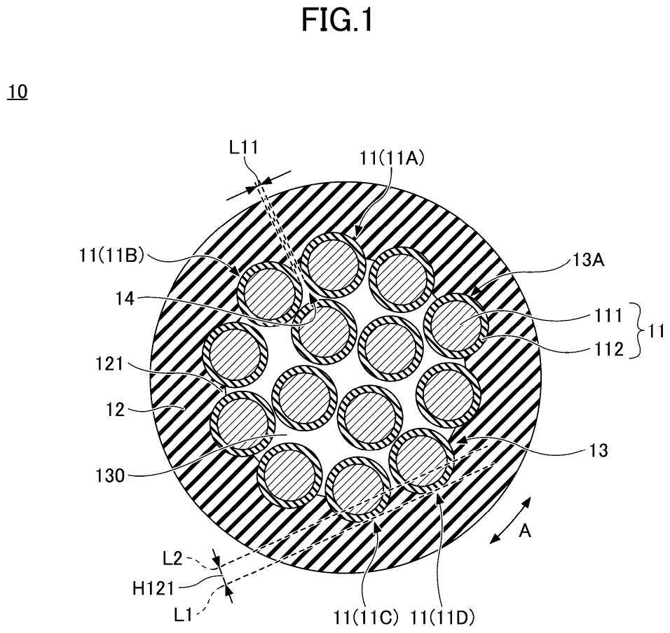

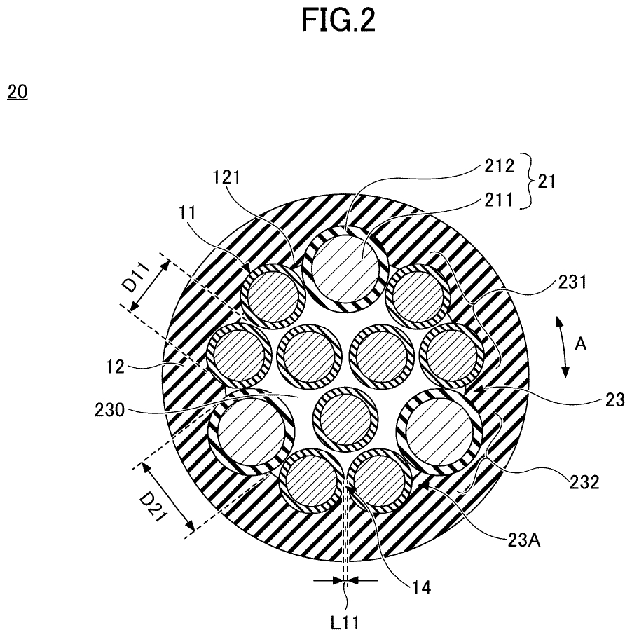

FIG. 1 through FIG. 5 illustrate configuration examples of a cross section of a multicore cable according to the present embodiment perpendicular to a longitudinal direction. Hereinafter, the configuration of the multicore cable according to the present embodiment will be described mainly using FIG. 1, and the multicore cables of FIG. 2 through FIG. 5 will be described by describing configurations that differ from the configuration of a multicore cable 10 of FIG. 1, as required. For this reason, the matters described with reference to FIG. 1 are common to the multicore cables of FIG. 2 through FIG. 5, unless indicated otherwise. Each of FIG. 1 through FIG. 5 schematically illustrates each member in order to describe the configuration or the like of the multicore cable of the present embodiment, and a size or the like are not limited to those of FIG. 1 through FIG. 5. For the sake of convenience considering a paper width, only some of the same members in the drawings are designated by reference numerals, and illustration of the reference numerals may be omitted.

FIG. 1 is a cross sectional view taken of the multicore cable 10 according to the present embodiment along a plane perpendicular to the longitudinal direction. A direction perpendicular to a paper surface in FIG. 1 is the longitudinal direction of the multicore cable.

As illustrated in FIG. 1, the multicore cable 10 of the present embodiment includes a core 13 including a plurality of insulated wires 11, and an outer sheath 12 covering an outer surface 13A of the core 13.

Each member included in the multicore cable according to the present embodiment will be described.
(1) Core
(1-1) Members Included in Core

The core 13 may include the plurality of insulated wires 11.

### (1-1-1) Insulated Wire

The insulated wire 11 may include a central conductor 111, and an insulator 112 covering an outer surface of the central conductor 111.

### (Central Conductor)

The central conductor 111 may be composed of a single metal element wire or a plurality of metal element wires. In a case where the central conductor 111 includes the plurality of metal element wires, the plurality of metal elements may be twisted together. That is, in the case where the central conductor 111 includes the plurality of metal element wires, the central conductor 111 may be a stranded conductor of the plurality of metal element wires.

A material used for the central conductor 2111 is not particularly limited, but one or more materials selected from copper, annealed copper, and copper alloys, for example, may be used for a base material. Examples of the copper alloys include tin-containing copper and silver-containing copper. The central conductor 111 may be made solely of the base material, or a surface of the base material may be plated with silver-plated annealed copper, nickel-plated annealed copper, tin-plated annealed copper, or the like. When plating the surface of the base material, one or more materials selected from silver, tin, nickel, or the like, for example, may be suitably used as a plating material.

### (Insulator)

A material used for the insulator 112 is not particularly limited, but may include one or more kinds of resins selected from fluororesins, such as polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETFE), or the like, polyester resins, such as polyethylene terephthalate (PET) or the like, and the like. Particularly, the insulator 112 preferably includes a fluororesin.

Although the insulator 112 may be made solely of the resin described above, the insulator 112 may include various kinds of additives, such as a flame retardant or the like, as required. Moreover, the insulator 112 may or may not be or not crosslinked.

As will be described later, it may be regarded that the noise generated when the multicore cable 10 is bent is caused by the core 13 hitting the outer sheath 12 when the multicore cable being bent has a gap between the core 13 and the outer sheath 12, and the core 13 moving along an inner periphery of the outer sheath 12 as indicated by a left right arrow A in FIG. 1 in a cross section perpendicular to the longitudinal direction of the multicore cable 10, causes the core 13 to rub against the outer sheath 12 in a case where the fluororesin is used for the insulator 112 forming the outer cover of the insulated wire 11, the core 13 may easily move along the inner periphery of the outer sheath 12. However, in the multicore cable according to the present embodiment, even in the case where the insulator 112 is made of the fluororesin, it is possible to prevent the core 13 from moving along the inner periphery of the outer sheath 12, and reduce the generation of the noise. For this reason, a particularly high effect of reducing the noise can be exhibited in the case where the fluororesin is used for the insulator 112 of the insulated wire 11.

Moreover, by using the fluororesin as the material used for the insulator 112, a thickness of the insulator 112 can be reduced, and the diameter of the insulated wire 11 or the entire multicore cable according to the present embodiment including the insulated wire 11, can be reduced.

As will be described later, the multicore cable according to the present embodiment may include insulated wires having different outer diameters. More particularly, as in a multicore cable 20 illustrated in FIG. 2, for example, the multicore cable 20 may include, as insulated wires, a first insulated wire 11, and a second Insulated wire 21 having an outer diameter different from an outer diameter of the first insulated wire 11. In this case, each insulated wire may also include a central conductor and an insulator, and each member may be configured as described above. That is, the first insulated wire 11 may include a central conductor 111 and an insulator 112, and the second insulated wire 21 may include a central conductor 211 and an insulator 212, respectively. Each of the central conductors and the insulators may be configured as described above.

### (1-1-2) Twisted Pair Insulated Wire

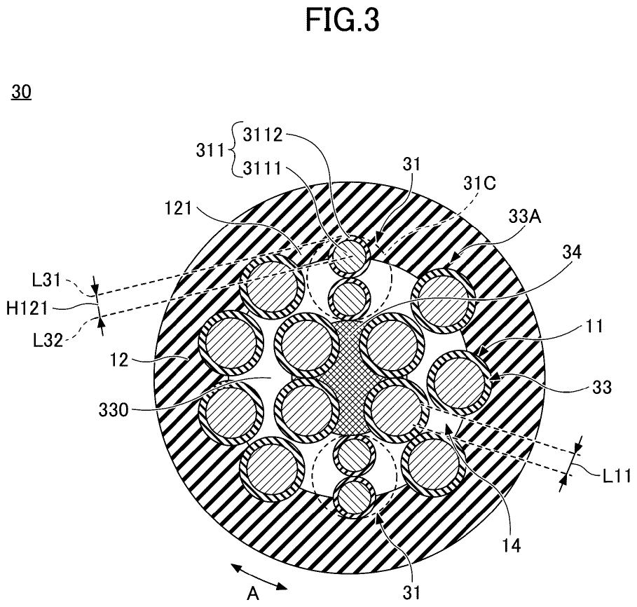

As in multicore cables 30 through 50 illustrated in FIG. 3 through FIG. 5, the core may include a twisted pair insulated wire 31 having two insulated wires 311 twisted together.

Each of the insulated wires 311 included in the twisted pair insulated wire 31 may be configured in the same manner as in the case of the insulated wire 11. That is, each of the insulated wires 311 may include a central conductor 3111 and an insulator. 3112, and each member may have the configuration described above. For this reason, a description of such members will be omitted.

A twist pitch at which the insulated wires 311 forming the twisted pair insulated wire 31 are twisted together is not particularly limited, but is preferably greater than or equal to 4 mm and less than or equal to 15 mm, and more preferably greater than or equal to 7 mm and less than or equal to 11 mm, for example.

### (1-1-3) Inclusion

For example, as in the multicore cable 30 illustrated in FIG. 3, the core 33 may further include an inclusion 34, as required.

The inclusion 34 may be composed of fibers such as staple yarns, nylon yarns, or the like. The inclusion may be composed of high tensile fibers.

The inclusion 34 can be disposed in a gap surrounded by the insulated wires.

Because the core includes the inclusion, it is possible to easily perform the work that forms the core by twisting the insulated wires together.

Although the inclusion 34 is disposed only in the example of the multicore cable 30, among the multicore cables 10 through 50, the inclusion 34 may be disposed in cables other than the multicore cable 30, as required.

### (1-2) Configuration of Core

As described above, the core may include a plurality of insulated wires, and the number and configuration of the insulated wires may be selected according to the application or the like of the multicore cable including the core, and are not particularly limited. Configuration examples of the core included in the multicore cable will be described with reference to FIG. 1 through FIG. 5. However, the configuration of the insulated wire forming the core is not limited to the cases illustrated in FIG. 1 through FIG. 5.

### (1-2-1) First Configuration Example

In a first configuration example, as in the multicore cable 10 illustrated in FIG. 1, the plurality of insulated wires included in the core 13 include only one kind of insulated wire 11 having the same configuration, such as the outer diameter or the like. Although the core 13 of the multicore cable 10 illustrated in FIG. 1 includes fourteen insulated wires 11, the core 13 is not limited to such an embodiment, and may include an arbitrary number of insulated wires according to an equipment or the like to which the multicore cable 10 is connected.

The plurality of insulated wires 11 included in the multicore cable 10 may be twisted together along the longitudinal direction, to form the core 13. Hence, by twisting together the plurality of insulated wires 11 to form the core 13, in the case where the multicore cable 10 is bent and a force is applied to each insulated wire 11, for example, each insulated wire 11 does not move individually but moves integrally as the core 13. A twisting direction of the plurality of insulated wires 11 is not particularly limited, and may be an arbitrary direction. A twist pitch of the plurality of insulated wires 11 included in the core 13 is not particularly limited, but is preferably greater than or equal to 15 mm and less than or equal to 50 mm, and more preferably greater than or equal to 25 mm and less than or equal to 40 mm. When the twist pitch of the plurality of insulated wires is set to a value greater than or equal to 15 mm, it is possible to particularly increase a productivity of the multicore cable. When the twist pitch of the plurality of insulated wires is set to a value less than or equal to 50 mm, a shape of a cross section perpendicular to the longitudinal direction of the core 13 can be made close to a circular shape, and a shape of a cross section perpendicular to the longitudinal direction of the multicore cable 10 can also be made close to a circular shape.

In the other configuration examples described below, the twist pitch of the plurality of insulated wires included in the core is preferably falls within the range described above.

The core 13 preferably has a gap 14 between at least one pair of adjacent insulated wires 11 among the insulated wires 11 located on the outer peripheral side of the core 13. That is, among the insulated wires 11 located on the outer peripheral side of the core 13, at least one pair of adjacent insulated wires 11 are preferably disposed with the gap provided therebetween.

The outer peripheral side of the core 13 can also be referred to as the outer surface 13A side of the core 13, and the insulated wire 11 located on the outer peripheral side of the core can form the outer surface 13A of the core 13. In addition, one pair of adjacent insulated wires 11 refers to two insulated wires 11 that are adjacent to each other along the outer periphery of the core, in the cross section perpendicular to the longitudinal direction of the multicore cable 10.

Because the gap 14 is provided between at least one pair of adjacent insulated wires 11 among the insulated wires 11 located on the outer peripheral side of the core 13, even in a case where the pair of insulated wires is displaced when the multicore cable 10 is bent, it is possible to reduce a force from being applied to the pair of insulated wires so as to press against each other. For this reason, when the multicore cable 10 is bent, it is possible to reduce a force applied to a convex portion 121, which is disposed between the pair of insulated wires 11 and will be described later, to increase the anchor effect by the convex portion 121, and reduce generation of the noise.

All of the insulated wires 11 located on the outer peripheral side of the core 13 may have the gap between the adjacent insulated wires 11. The presence of the gap 14 between at least one pair of adjacent insulated wires 11 among the insulated wires 11 located on the outer peripheral side of the core 13, can be evaluated in an arbitrary cross section perpendicular to the longitudinal direction of the multicore cable 10.

Further, the core 13 includes a portion where a distance L11 between the insulated wires 11 located on the outer peripheral side of the core 13 is greater than or equal to 0.01 mm, and such a portion is preferably provided at one or more locations, and more preferably provided at two or more locations.

When the core 13 includes the portion where the distance L11 between the insulated wires 11 located on the outer peripheral side of the core 13 is greater than or equal to 0.01 mm at one or more locations, a height H121 of the convex portion 121, which is formed between the insulated wires 11 and will be described later, can be made sufficiently large. For this reason, when the multicore cable 10 is bent, the effect of restricting the movement of the core 13 increases, and the generation of the noise can be particularly reduced.

Because the distance between the insulated wires 11 located on the outer peripheral side of the core 13 can be set to a value greater than or equal to 0.01 mm with respect to all of the insulated wires 11, an upper limit value of the number of portions where the distance between the insulated wires 11 located on the outer peripheral side of the core 13 satisfies the range described above is not particularly limited.

The upper limit value of the distance L11 between the insulated wires 11 located on the outer peripheral side of the core 13 is not particularly limited. However, if the upper limit value is set excessively large, the outer diameter of the core 13 and the outer diameter of the multicore cable 10 increase, and thus, the upper limit value is preferably less than or equal to 0.03 mm, for example.

The distance L11 between the insulated wires 11 located on the outer peripheral side of the core 13 refers to a shortest distance between an insulated wire 11A and an insulated wire 11B that are adjacent to each other as illustrated in FIG. 1, for example.

In the following other configuration examples of the core, differences from the first configuration example will mainly be described.

### (1-2-2) Second Configuration Example

As a second configuration example, as in the multicore cable 20 illustrated in FIG. 2, the configuration may have a core 23 including insulated wires having different outer diameters. The core 23 of multicore cable 20 illustrated in FIG. 2 includes, as the plurality of insulated wires, a first insulated wire 11, and a second insulated wire 21 having an outer diameter larger than an outer diameter of first insulated wire 11. That is, an outer diameter D11 of the first insulated wire 11 and an outer diameter D21 of the second insulated wire 21 satisfy a relationship D11<D21.

As described above, in the case where the core 23 includes the first insulated wire 11 and the second insulated wire 21 having different outer diameters, the second insulated wire 21 having the larger outer diameter is preferably disposed on the outer peripheral side of the core 23, that is, on the outer surface 23A side of the core 23.

By disposing the second insulated wire 21 having the larger outer diameter on the outer peripheral side of the core 23, it is possible to reduce the outer diameter of the core 23, and reduce the diameter of the multicore cable 20. All of the second insulated wires 21, included in the core 23 and having the larger outer diameter, may be disposed on the outer peripheral side of the core 23.

In addition, the first insulated wire 11 and the second insulated wire 21 may be disposed on the outer peripheral side of the core 23. In the cross section perpendicular to the longitudinal direction of the core 23, the first insulated wires 11 and the second insulated wires 21 are preferably alternately arranged along the outer periphery of the core 23. As illustrated in FIG. 2, it is possible to dispose a plurality of first insulated wires 11, or dispose a plurality of second insulated wires 21, or dispose a plurality of first insulated wires 11 and a plurality of second insulated wires 21, and further, a first region including the first insulated wires 11 and a second region 232 including the second insulated wires 21 may be alternately arranged. By alternately arranging the first region 231 including the first insulated wires 11 and the second region 232 including the second insulated wires 21 along the outer periphery of the core 23, the second insulated wires 21 having the larger outer diameter can be distributed on the outer periphery of the core 23. For this reason, the shape of the cross section perpendicular to the longitudinal direction of the core 23 can be made close to a circular shape. In addition, it is possible to particularly increase the height of the convex portion which will be described later, disposed between the first insulated wire 11 and the second insulated wire 21 which are adjacent to each other, and particularly reduce the generation of the noise.

A plurality of first regions 231 and a plurality of second regions 232 may be provided along the outer periphery of the core 23. In the multicore cable 20 illustrated in FIG. 2, the core 23 has three first regions 231 and three second regions 232.

In the multicore cable 20 illustrated in FIG. 2, the core 23 includes two kinds of insulated wires, that is, the first insulated wires 11 and the second insulated wires 21, as the insulated wires, but the present disclosure is not limited to such a configuration. The core of the multicore cable according to the present embodiment may include three or more kinds of insulated wires having different configurations, such as the outer diameter or the like.

Although the core 23 of the multicore cable 20 illustrated in FIG. 2 includes twelve insulated wires, the core 23 is not limited to such a configuration, and may have an arbitrary number of insulated wires according to the equipment or the like to which the multicore cable 20 is connected.

The plurality of insulated wires included in the multicore cable 20, that is, the first insulated wires 11 and the second insulated wires 21, can be twisted together along the longitudinal direction to form the core 23. The twisting direction of the plurality of insulated wires is not particularly limited, and may be an arbitrary direction.

### (1-2-3) Third Configuration Example Through Fifth Configuration Example

As a third configuration example through a fifth configuration example, as in the multicore cable 30 illustrated in FIG. 3, for example, some of the plurality of insulated wires among the plurality of insulated wires included in a core 33 may have a configuration in which two insulated wires 311 are twisted together in advance along the longitudinal direction to form a twisted pair insulated wire 31. That is, the core may include a twisted pair insulated wire having two insulated wires twisted together. When the core includes the twisted pair insulated wire, the multicore cable can be applied to a wider range of applications. In addition, by including the twisted pair insulated wire in the core, it is possible to improve the handleability when performing the wiring or the like.

The position where the twisted pair insulated wires are disposed is not particularly limited, but at least some of the twisted pair insulated wires may be arranged on the outer peripheral side of the core, that is, on the outer surface side of the core, and as illustrated in FIG. 3 through FIG. 5, for example, all of the twisted pair insulated wires may be arranged on the outer peripheral side of the core.

Although the multicore cable 30, the multicore cable 40, and the multicore cable 50 illustrated in FIG. 3 through FIG. 5 illustrate examples in which the core 33, a core 43, and a core 53 includes two pairs of twisted pair insulated wires 31, respectively, the present disclosure is not limited to such configurations, and the multicore cable 30, the multicore cable 40, and the multicore cable 50 may include one pair of twisted pair insulated wire or three or more pairs of twisted pair insulated wires. In addition, the core included in the multicore cable may include two or more kinds of twisted pair insulated wires in which the insulated wires forming the twisted pair insulated wires have different outer diameters or the like.

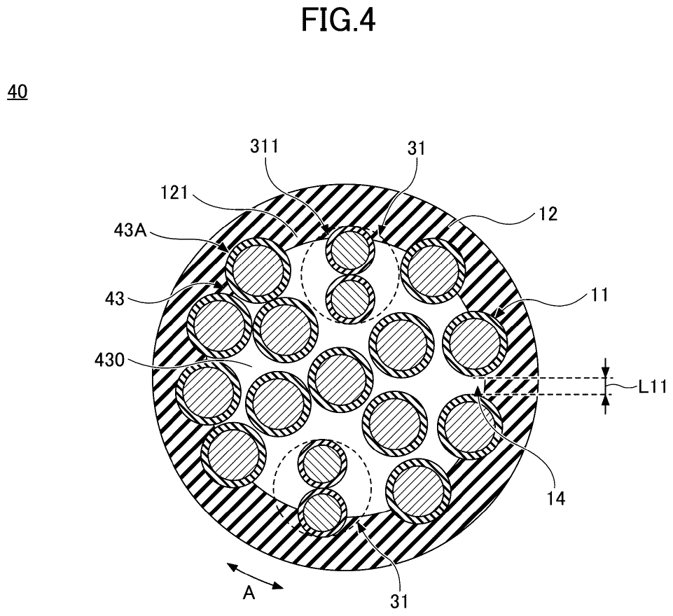

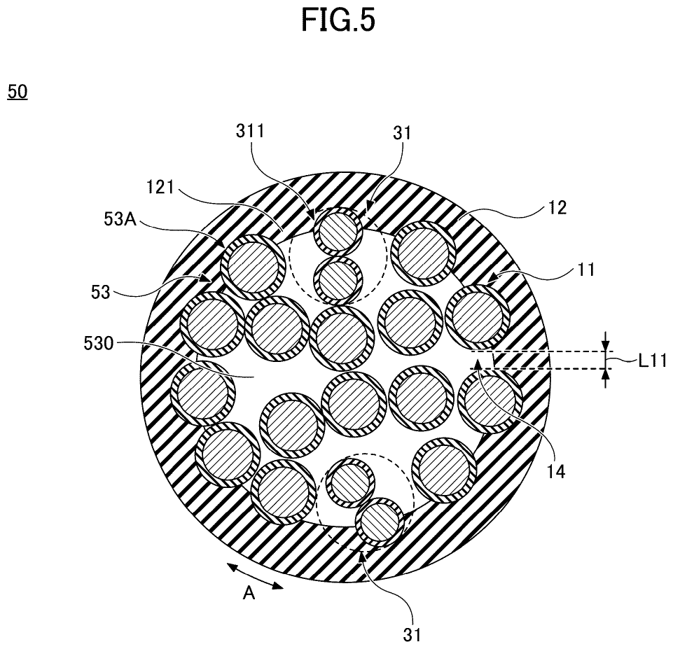

Although the core 33 of the multicore cable 30 illustrated in FIG. 3 includes eleven insulated wires 11 in addition to the twisted pair insulated wires 31, the present disclosure is not limited to such a configuration. For example, the core 43 of the multicore cable 40 illustrated in FIG. 4 may include thirteen insulated wires 11, and the core 53 of the multicore cable 50 illustrated in FIG. 5 may include fifteen insulated wires 11. In addition, the present disclosure is not limited to any of the configurations described above, and an arbitrary number of insulated wires may be provided, or the insulated wires may have different configurations, such as the outer diameter or the like, according to the equipment or the like to which the mufti core cable is connected.

The plurality of insulated wires 11 and the twisted pair insulated wires 31 included in the multicore cables 30 through 50 can be twisted together along the longitudinal direction to form the cores 33 through 53. The twisting direction of the plurality of insulated wires 11 and the twisted pair insulated wires 31 is not particularly limited, and may be an arbitrary direction.

### (2) Outer Sheath

The multicore cable 10 according to the present embodiment may include the outer sheath 12 covering the outer surface of the core 13.

The present inventors studied the cause of the noise that occurs when the multicore cable is bent. When the multicore cable having the gap between the core and the outer sheath is bent, the core comes into contact with the outer sheath, and further, in the cross section perpendicular to the longitudinal direction of the multicore cable, the core 13 moves along the inner periphery of the outer sheath 12, as indicated by the left right arrow A in FIG. 1, and it was regarded that the core 13 rubs against the outer sheath 12, thereby generating the noise.

Hence, the outer sheath 12 of the multicore cable 10 according to the present embodiment may include the convex portion 121, disposed between the insulated wires located on the outer peripheral side of the core 13, and in contact with at least a portion of the surfaces of the insulated wires 11.

The outer sheath 12 is disposed between the insulated wires located on the outer peripheral side of the core 13, and includes the convex portion 121 in contact with at least a portion of the surfaces of the insulated wires 11, so that the outer sheath 12 can be configured to penetrate in-between the insulated wires 11 located on the outer peripheral side of the core 13. For this reason, the convex portion 121 functions as the anchor of the outer sheath 12, and it is possible to reduce the noise generated by the rubbing between the outer sheath 12 and the core 13 that would otherwise be caused by the core 13 moving along the inner periphery of the outer sheath 12 when the multicore cable 10 is bent. Accordingly, compared to a case where the outer sheath 12 does not have the convex portion 121, it is possible to prevent the rubbing between the outer sheath 12 and the core 13, and reduce the generation of the noise.

### (2-1) Convex Portion

The shape or the like of the convex portion 121 is not particularly limited, as long as the convex portion 121 is disposed between the insulated wires 11 located on the outer peripheral side of the core 13 and is in contact with at least a portion of the surfaces of the insulated wires.

The height of the convex portion 121 is preferably greater than or equal to 0.05 mm, and more preferably greater than or equal to 0.07 rm. By setting the height of the convex portion 121 to a value greater than or equal to 0.05 mm, it is possible to increase the effect of restricting the movement of the core 13 when the multicore cable 10 is bent, and particularly reduce the generation of the noise.

An upper limit of the height of the convex portion 121 is not particularly limited, but is preferably less than or equal to 0.5 mm, and more preferably less than or equal to 0.4 mm, for example.

The outer sheath 12 can be formed by solid extrusion, for example, and the height of the convex portion 121 can be selected by adjusting the shape of a die, the pressure and temperature at the time of injecting the resin, the distance between the insulated wires 11 forming the core 13, or the like. In this case, it is preferable to adjust the pressure or the like when injecting the resin so that the resin of the outer sheath 12 does not fill an inside 131 of the core 13, and extrude the resin.

When the height of the convex portion 121 is set to a value less than or equal to 0.5 mm, it becomes unnecessary to excessively increase the pressure applied to the resin and the temperature when forming the outer sheath 12, to thereby increase the productivity.

As described above, in the cross section perpendicular to the longitudinal direction of the multicore cable 10 according to the present embodiment, the inside of the core 13 is preferably not filled with the resin of the outer sheath 12. In other words, the core 13 preferably includes a void 130 in the cross section.

The configuration in which the void 130 is provided inside the core 13, that is, the configuration in which a region surrounded by the plurality of insulated wires 11 inside the core 13 includes a space not penetrated by the outer sheath 12, can reduce the force applied to the plurality of insulated wires 11 included in the core 13 when the multicore cable 10 is bent. For this reason, even in the case where the multicore cable 10 is repeatedly bent, the breaking or the like of the plurality of insulated wires 11 can be prevented. That is, a flexing resistance of the multicore cable 10 can be improved. Similarly, in the multicore cables 20 through 50 illustrated in FIG. 2 through FIG. 5, the cores 23 through 53 preferably include voids 230 through 530 therein.

Next, a method for measuring the height of the convex portion 121 will be described. An example of a case will be described which determines the height H121 of the convex portion 121 located between an insulated wire 11C and an insulated wire 11D that are adjacent to each other in the cross section perpendicular to the longitudinal direction of the multicore cable 10 illustrated in FIG. 1.

First, in the cross section perpendicular to the longitudinal direction of the multicore cable 10, a common tangent L1 of the insulated wire 11C and the insulated wire 11D that are adjacent to each other, is drawn. Next, a straight line L2, that is parallel to the common tangent L1 and passes through an end portion of the convex portion 121 on the inner peripheral side of the core 13, is drawn. In this case, a distance between the common tangent L1 and the straight line L2 is the height H1121 of the convex portion 121.

The other convex portions 121 disposed between the insulated wires 11 located on the outer peripheral side of the core 13 can be measured in a similar manner. In the case of the multicore cable 10 illustrated in FIG. 1, ten insulated wires 11 are disposed on the outer peripheral side of the core 13, and ten convex portions 121 are disposed therebetween. In this case, it is preferable that the height H121 of each of the ten convex portions 121 walls within the range described above.

In a case where the twisted pair insulated wire 31 is provided as in the multicore cable 30 illustrated in FIG. 3, the height of the convex portion 121, located between the twisted pair insulated wire 31 and the insulated wire 11 that are adjacent to each other, can be measured in a manner similar to the case described above. First, in the cross section perpendicular to the longitudinal direction of the multicore cable 30, a common tangent L31 between the insulated wire 11, and a circumcircle 31C of the twisted pair insulated wire 31 that is adjacent to the insulated wire 11, is drawn. Next, a straight line L32, that is parallel to the common tangent L31 and passes through an end portion of the convex portion 121 on the inner peripheral side of the core 33, is drawn. In this case, a distance between the common tangent L31 and the straight line L32 is the height H121 of the convex portion 121.

The multicore cable according to the present embodiment is preferably configured so that, when the multicore cable is bent, the outer sheath follows the insulated wire disposed on the outer peripheral side of the core.

More particularly, the insulated wire 11 disposed on the outer peripheral side of the core 13, for example, is preferably in contact with the convex portion 121 so that the core 13 does not slide with respect to the outer sheath 12.

The insulated wire 11 disposed on the outer peripheral side of the core 13, in contact with the convex portion 121 so as not to slide with respect to the outer sheath 12, refers to a state where the insulated wire 11 and the convex portion 121 are at least partially in close contact with each other, for example.

In particular, when the multicore cable 10 is bent, the insulated wire 11 disposed on the outer peripheral side of the core 13 and the convex portion 121 are preferably at least partially in contact with each other at the bent portion.

According to the configuration described above, when the multicore cable 10 is bent, it is possible to restrict the movement of the core 13 along the inner periphery of the outer sheath 12 indicated by the left right arrow A in FIG. 1. For this reason, it is possible to reduce the generation of the noise when the multicore cable is bent.

The cross sectional shape of the multicore cable 10 at the bent portion can be confirmed in the following manner, for example. First, when the multicore cable 10 is bent so that an angle between portions of the multicore cable 10 sandwiching the bent portion becomes 90 degrees, that is, the bending angle becomes 90 degrees, a maximum value of the thickness in the bending direction of the multicore cable 10 at the bent portion is measured. Then, with respect to a multicore cable 10 prepared separately, a cross section perpendicular to the longitudinal direction is pressed along an arbitrary uniaxial direction along the diameter of the cross section, so that a maximum value of the thickness of the multicore cable 10 along the pressed direction becomes the maximum value of the thickness of the multicore cable measured at the bent portion. In this state, because the pressed cross sectional shape of the multicore cable 10 prepared separately, corresponds to the cross sectional shape of the bent portion of the multicore cable 10, the state of the cross section at the bent portion of the multicore cable 10 can be evaluated by evaluating the state of the pressed cross section of the multicore cable 10 prepared separately.

The insulated wire 11 located on the outer peripheral side of the core 13 is preferably in direct contact with the outer sheath 12. This is because the insulated wire 11 and the outer sheath 12 can be in close contact with each other when the insulated wire 11 is in direct contact with the outer sheath 12 including the convex portion 121. For this reason, in the case where the multicore cable 10 is bent, it is possible to prevent the core 13 from moving along the inner periphery of the outer sheath 12, and particularly reduce the generation of the noise.

The insulated wire 11 in direct contact with the outer sheath 12 refers to a state where both of these members are in direct contact with each other without another member interposed therebetween, and that other members, such as a tape or the like, or various kinds of layers, are not disposed between both of these members.

A material used for the outer sheath 12 is not particularly limited, but because the outer sheath is preferably formed by solid extrusion, the material preferably includes a thermoplastic resin, and preferably includes one or more kinds selected from polyethylene, polyvinyl chloride (PVC), or the like, for example.

By including the thermoplastic resin in the outer sheath 12, the convex portion can easily be formed between the insulated wires 11 located on the outer peripheral side of the core 13.

The outer sheath 12 may be composed solely of the thermoplastic resin, but the outer sheath 12 may include various kinds of additives, such as a flame retardant or the like, as required. In addition, the outer sheath 12 may or may not be crosslinked.

Because the outer sheath 12 includes the thermoplastic resin as the resin component, it is possible to form the convex portion described above, and in the case where the multicore cable 10 is bent, the core 13 can be particularly prevented from sliding with respect to the outer sheath 12, and the generation of the noise can be particularly reduced.

### Exemplary Implementations

Hereinafter, the present disclosure will be described with reference to specific exemplary implementations, but the present invention is not limited to such exemplary implementations.

### (Evaluation Method)

First, an evaluation method for the multicore cables manufactured in the following experimental examples will be described.

### (1) Height of Convex Portion

A method of determining the height 11121 of the convex portion 121 will be described by referring to the case of the multicore cable 10 illustrated in FIG. 1 as an example.

First, in the cross section perpendicular to the longitudinal direction of the multicore cable 10, the common tangent L1 of the insulated wire 11C and the insulated wire 110 that are adjacent to each other, is drawn. Next, the straight line L2, that is parallel to the common tangent L1 and passes through the end portion of the convex portion 121 on the inner peripheral side of the core 13, is drawn. Then, the distance between the common tangent L1 and the straight line L2 is measured, and defined as the height H121 of the convex portion 121.

In an arbitrary cross section of the multicore cable manufactured in each of the following experimental examples, the measurement described above was performed for all of the convex portions formed between the insulated wires located on the outer peripheral side of the core, and the minimum value and the maximum value were determined.

### (2) Distance Between Insulated Wires Disposed on Outer Peripheral Side of Core

In the cross section perpendicular to the longitudinal direction of the multicore cables manufactured in the following experimental examples, the shortest distance between adjacent insulated wires was measured for the insulated wires disposed on the outer peripheral side of the core, and the number of gaps with the distance between the insulated wires greater than or equal to 0.01 mm was counted. In addition, the minimum value and the maximum value of the distance between the insulated wires were determined.

### (3) Twist Pitch

The twist pitch of the insulated wires forming the core, and the twist pitch of the insulated wires forming the twisted pair insulated wire, were measured by the method prescribed in JIS C 3002 (1992).

### (4) Outer Diameters of Central Conductor, Insulator, and Outer Sheath

The outer diameters of the central conductor and the insulator of the insulated wires used in the multicore cables manufactured in the following experimental examples, and the outer diameter of the outer sheath of these multicore cables, were measured using a micrometer by the method prescribed in JIS C 3002 (1992).

In addition, the outer diameter of the core of the multicore cables was also measured in a similar manner, and the thickness of the outer sheath was determined by subtracting the outer diameter of the core from the outer diameter of the outer sheath of the multicore cables to obtain a difference, and dividing the difference by two.

### (5) Noise Test

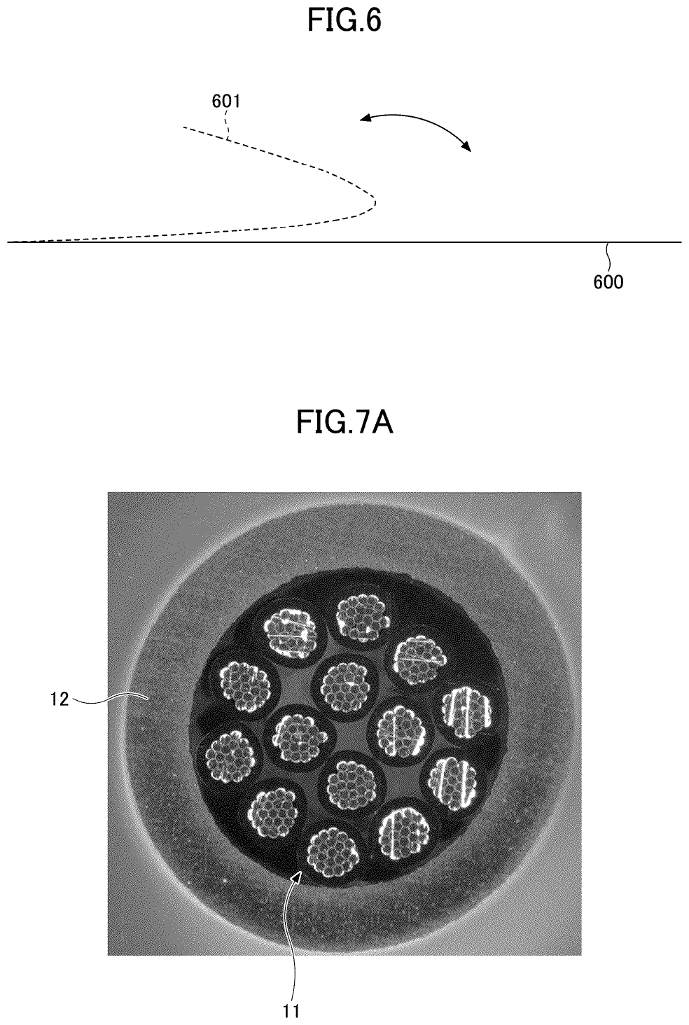

The multicore cables manufactured in the following experimental examples were repeatedly bent at an arbitrary position along the longitudinal direction. That is, the end portion of the multicore cable was moved as indicated by a left right arrow in FIG. 6, and the multicore cable was caused to repeatedly make a transition between a state of a multicore cable 600 before the bending and a state of a multicore cable 601 after the bending. Then, a test was performed to determine whether or not the noise is generated when the multicore cable is bent, that is, whether or not a sound is output.

In order to prevent the evaluation criteria from varying depending on a tester who conducts the test, all of the multicore cables were tested by the same tester.

Next, the multicore cable of each experimental example will be described in the following.

### Experimental Example 1

The multicore cables of exierimerntal examples 1-1 through 1-3 were manufactured. The experimental example 1-1 and the experimental example 1-2 are comparative examples, and the experimental example 1-3 is an exemplary implementation.

In each of the experimental examples 1-1 through 1-3, the multicore cable was manufactured so that the configuration of the core 13 becomes the same as the configuration of the multicore cable 10 illustrated in FIG. 1 in the cross section perpendicular to the longitudinal direction.

The specifications of the manufactured multicore cables are summarized in Table 1. In Table 1, 14C indicates that there are fourteen insulated wires. In Table 3 which will be described later, 2C in the twisted pair insulated wire (C) similarly indicates that there are two insulated wires.

In the experimental examples 1-1 and 1-2, the outer sheath illustrated in Table 1 was formed on the outer periphery of the core by pipe extrusion. In the experimental example 1-3, the outer sheath 12 illustrated in Table 1 was formed by solid extrusion so as to cover the outer surface 13A of the core 13.

TABLE 1

| Insulated wire | Central | Material | — | Tin plated annealed |
|---|---|---|---|---|
| | conductor | | | copper wire |

| | Configuration | Conductors/ | 20/0.05 |
|---|---|---|---|
| | | mm | |
| | Outer diameter | mm | 0.26 |
| Insulator | Material | — | ETFE |
| | Thickness | mm | 0.06 |
| | Outer diameter | mm | 0.38 |

| Aggregate (core) | Configuration | | — | 14 C |
|---|---|---|---|---|
| | Twist pitch | | mm | 30 |
| | Gap of | Number | Location | 8 |
| | 0.01 mm | Minimum value | mm | 0.01 |
| | or greater | Maximum value | mm | 0.01 |

| Outer sheath | Material | — | PVC |
|---|---|---|---|
| | Thickness | mm | 0.37 |
| | Outer diameter | mm | 2.4 |

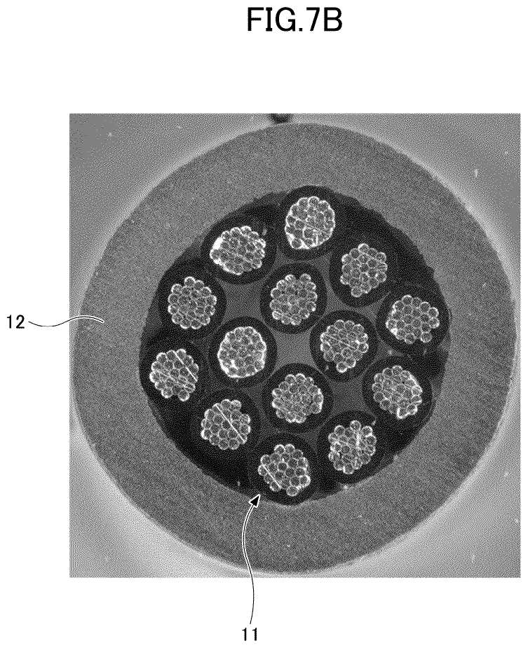

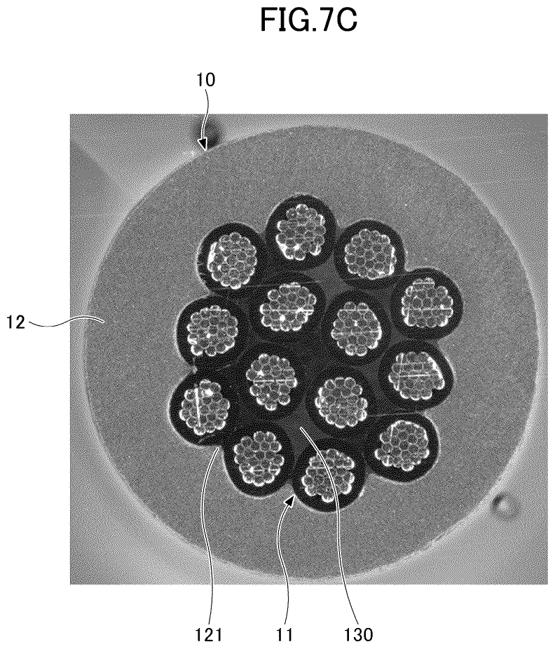

Photographs of cross sections of the multicore cables along the plane perpendicular to the longitudinal direction are illustrated in FIG. 7A through FIG. 7C. FIG. 7A illustrated the multicore cable of the experimental example 1-1, FIG. 7B illustrates the multicore cable of the experimental example 1-2, and FIG. 7C illustrates the multicore cable of the experimental example 1-3.

As illustrated in the FIG. 7A and FIG. 7B, the outer sheath 12 of each of the multicore cables of the experimental example 1-1 and the experimental example 1-2 did not include the convex portion 121.

In contrast, as illustrated in FIG. 7C, it was confirmed that the outer sheath 12 of the multicore cable 10 of the experimental example 1-3 includes the convex portion 121, and the convex portion 121 is in contact with at least a portion of the surfaces of the insulated wires 11. It was also confirmed that the insulated wire 11 and the convex portion 121 are in close contact with each other, and that the insulated wire 11 and the convex portion 121 are in direct contact with each other. The minimum height of the convex portion was 0.101 mm, and the maximum height of the convex portion was 0.132 mm. In the multicore cable 10 of the experimental example 1-3, the insulated wire 11 located on the outer peripheral side of the core was in direct contact with the outer sheath 12. In addition, it was confirmed that, in the multicore cable 10 of the experimental example 1-3, the resin of the outer sheath does not penetrate into the inside of the core, and the void 130 is formed.

It was also confirmed that, when the multicore cable 10 of the experimental example 1-3 is bent, the insulated wire disposed on the outer peripheral side of the core and the convex portion are at least partially in contact with each other at the bent portion.

Further, in one cross section perpendicular to the longitudinal direction of the multicore cable, the number of gaps 14 having the distance L11 greater than or equal to 0.01 mm between the adjacent insulated wires disposed on the outer peripheral side of the core 13, and the minimum value and the maximum value of the distance L11, were measured for the experimental example 1-3. The measured results are illustrated in Table 1.

When the noise test described above was performed on the multicore cables of the experimental examples 1-1 through 1-3, the generation of the noise was confirmed for the experimental example 1-1 and the experimental example 1-2. In contrast, no generation of the noise was observed in the multicore cable of the experimental example 1-3.

### Experimental Example 2

Multicore cables of the following experimental examples 2-1 and 2-2 were manufactured. The experimental example 2-1 is a comparative example, and the experimental example 2-2 is an exemplary implementation.

In the experimental example 2-1 and the experimental example 2-2, the multicore cables were manufactured so that the configuration of the core becomes the same as the configuration of the core 23 of the multicore cable 20 illustrated in FIG. 2 in the cross section perpendicular to the longitudinal direction.

The specifications of the manufactured multicore cables are summarized in Table 2. In Table 2, “(A)×9+(B)×3” in an aggregate (core) column indicates the number of wires of the cable, and indicates that the cable includes nine first insulated wires (A) and three second insulated wires (B). In Table 3 through Table 5 which will be described later, similar designations are used to indicate the number of wires of the cable.

In the experimental example 2-1, the outer sheath was formed on the outer periphery of the core by pipe extrusion. In the experimental example 2-2, the outer sheath 12 was formed by solid extrusion, so as to cover the outer surface 23A of the core 23.

TABLE 2

| | | | | First insulated | Second insulated |
|---|---|---|---|---|---|
| | | | | wire (A) | wire (B) |
| Insulated | Central | Material | — | Tin plated annealed | Tin plated annealed |
| wire | conductor | | | copper wire | copper wire |

| | Configuration | Conductors/ | 20/0.05 | 30/0.05 |
|---|---|---|---|---|
| | | mm | | |
| | Outer diameter | mm | 0.26 | 0.32 |
| Insulator | Material | — | ETFE | ETFE |
| | Thickness | mm | 0.06 | 0.07 |
| | Outer diameter | mm | 0.38 | 0.45 |

| Aggregate (core) | Configuration | | — | (A) × 9 + (B) × 3 |
|---|---|---|---|---|
| | Twist pitch | | mm | 30 |
| | Gap of | Number | Location | 6 |
| | 0.01 mm | Minimum | mm | 0.01 |
| | or greater | value | | |

| Maximum | mm | 0.01 |
|---|---|---|
| value | | |

| Outer sheath | Material | — | PVC |
|---|---|---|---|
| | Thickness | mm | 0.36 |
| | Outer diameter | mm | 2.3 |

In the multicore cable of the experimental example 2-1, similar to the experimental example 1-1 and the experimental example 1-2, the outer sheath did not include the convex portion 121.

In contrast, as illustrated in FIG. 2, in the multicore cable 20 of the experimental example 2-2, it was confirmed that the outer sheath 12 includes the convex portion 121, the insulated wire 11 and the convex portion 121 are in close contact with each other, and the insulated wire 11 and the convex portion 121 are in direct contact with each other. The minimum value of the height of the convex portion was 0.094 mm, and the maximum value of the height was 0.152 mm. In the multicore cable 20 of the experimental example 2-2, the insulated wire located on the outer peripheral side of the core was in direct contact with the outer sheath. In addition, it was confirmed that in the multicore cable 20 of the experimental example 2-2, the resin of the outer sheath does not penetrate into the inside of the core, and that the void 230 is formed.

It was also confirmed that, when the multicore cable 20 of the experimental example 2-2 is bent, the insulated wire disposed on the outer peripheral side of the core and the convex portion were at least partially in contact with each other at the bent portion.

Further, in one cross section perpendicular to the longitudinal direction of the multicore cable of the experimental example 2-2, the number of gaps 14 in which the distance L11 between the adjacent insulated wires disposed on the outer peripheral side of the core 23 is greater than or equal to 0.01 mm, and the minimum value and the maximum value of the distance L11, were measured. The measured results are illustrated in Table 2.

When the noise test described above was performed on the multicore cables of the experimental examples 2-1 and 2-2, the generation of the noise was confirmed in the experimental example 2-1. In contrast, no generation of the noise was observed in the multicore cable of the experimental example 2-2.

### Experimental Example 3

Multicore cables of the following experimental examples 3-1 and 3-2 were manufactured. The experimental example 3-1 is a comparative example, and the experimental example 3-2 is an exemplary implementation.

In the experimental example 3-1 and the experimental example 3-2, the multicore cables were manufactured so that the configuration of the core becomes the same as the configuration of the core 33 of the multicore cable 30 illustrated in FIG. 3 in the cross section perpendicular to the longitudinal direction.

The specifications of the manufactured multicore cables are summarized in Table 3.

In the experimental example 3-1, the outer sheath was formed on the outer periphery of the core by pipe extrusion. In the experimental example 3-2, the outer sheath 12 was formed by solid extrusion, so as to cover the outer surface 33A of the core 33.

TABLE 3

| | | | | | Twisted pair |
|---|---|---|---|---|---|
| | | | | Insulated wire (A) | insulated wire (C) |
| Insulated | Central | Material | — | Tin plated annealed | Tin plated annealed |
| wire | conductor | | | copper wire | copper wire |
| | | Configuration | Conductors/mm | 20/0.05 | 20/0.05 |
| | | Outer diameter | mm | 0.26 | 0.26 |
| | Insulator | Material | — | ETFE | ETFE |
| | | Thickness | mm | 0.06 | 0.06 |
| | | Outer diameter | mm | 0.38 | 0.38 |
| | Twisting | Configuration | — | — | 2C |
| | | Twist pitch | mm | — | 9 |

| Aggregate (core) | Configuration | | — | (A) × 11 + (C) × 2 |
|---|---|---|---|---|
| | Twist pitch | | mm | 30 |
| | Gap of | Number | Location | 8 |
| | 0.01 mm | Minimum | mm | 0.01 |
| | or greater | value | | |
| | | Maximum | mm | 0.02 |
| | | value | | |

| Outer sheath | Material | — | PVC |
|---|---|---|---|
| | Thickness | mm | 0.39 |
| | Outer diameter | mm | 2.6 |

In the multicore cable of the experimental example 3-1, similar to the experimental example 1-1 and the experiment-al example 1-2, the outer sheath did not include the convex portion 121.

In contrast, in the multicore cable of the experimental example 3-2, it was confirmed that the outer sheath 12 includes the convex portion 121, the insulated wire 11 and the convex portion 121 are in close contact with each other, and the insulated wire 11 and the convex portion 121 ae in direct contact with each other. The minimum value of the height of the convex portion was 0.096 am, and the maximum value of the height was 0.131 mm. In the multicore cable 30 of the experimental example 3-2, the insulated wire located on the outer peripheral side of the core was in direct contact with the outer sheath. In addition, it was confirmed that in the multicore cable 30 of the experimental example 3-2, the resin of the outer sheath does not penetrate into the inside of the core, and that the void 330 is formed.

It was also confirmed that, when the multicore cable 30 of the experimental example 3-2 is bent, the insulated wire disposed on the outer peripheral side of the core and the convex portion were at least partially in contact with each other at the bent portion.

Further, in one cross section perpendicular to the longitudinal direction of the multicore cable of the experimental example 3-2, the number of gaps 14 in which the distance L11 between the adjacent insulated wires disposed on the outer peripheral side of the core 33 is greater than or equal to 0.01 nm, and the minimum value and the maximum value of the distance L11, were measured. The distance between the adjacent insulated wires refers to the distance between the insulated wires 11, and the distance between the circumcircle 31C of the twisted pair insulated wire 31 and the insulated wire 11. The measured results are illustrated in Table 3.

When the noise test described above was performed on the multicore cables of the experimental examples 3-1 and 3-2, the generation of the noise was confirmed in the experimental example 3-1. In contrast, no generation of the noise was observed in the multicore cable of the experimental example 3-2.

### Experimental Example 4

Multicore cables of the following experimental examples 4-1 and 4-2 were manufactured. The experimental example 4-1 is a comparative example, and the experimental example 4-2 is an exemplary implementation.

In the experimental example 4-1 and the experimental example 4-2, the multicore cables were manufactured so that the configuration of the core becomes the same as the configuration of the core 43 of the multicore cable 40 illustrated in FIG. 4 in the cross section perpendicular to the longitudinal direction.

The specifications of the manufactured multicore cables are summarized in Table 4.

In the experimental example 4-1, the outer sheath was formed on the outer periphery of the core by pipe extrusion. In the experimental example 4-2, the outer sheath 12 was formed by solid extrusion, so as to cover the outer surface 43A of the core 43.

TABLE 4

| | | | | | Twisted pair |
|---|---|---|---|---|---|
| | | | | Insulated wire (A) | insulated wire (C) |
| Insulated | Central | Material | — | Tin plated annealed | Tin plated annealed |
| wire | conductor | | | copper wire | copper wire |
| | | Configuration | Conductors/mm | 20/0.05 | 20/0.05 |
| | | Outer diameter | mm | 0.26 | 0.26 |
| | Insulator | Material | — | ETFE | ETFE |
| | | Thickness | mm | 0.06 | 0.06 |
| | | Outer diameter | mm | 0.38 | 0.38 |
| | Twisting | Configuration | — | — | 2C |
| | | Twist pitch | mm | — | 9 |

| Aggregate (core) | Configuration | | — | (A) × 13 + (C) × 2 |
|---|---|---|---|---|
| | Twist pitch | | mm | 35 |
| | Gap of | Number | Location | 9 |
| | 0.01 mm | Minimum | mm | 0.01 |
| | or greater | value | | |
| | | Maximum | mm | 0.15 |
| | | value | | |

| Outer sheath | Material | — | PVC |
|---|---|---|---|
| | Thickness | mm | 0.28 |
| | Outer diameter | mm | 2.5 |

In the multicore cable of the experimental example 4-1, similar to the experimental example 1-1 or the experimental example 1-2, the outer sheath did not include the convex portion 121.

In contrast, in the multicore cable of the experimental example 4-2, it was confirmed that the outer sheath 12 includes the convex portion 121, the insulated wire 11 and the convex portion 121 are in close contact with each other, and the insulated wire 11 and the convex portion 121 are in direct contact with each other. The minimum value of the height of the convex portion was 0.081 mm, and the maximum value of the height was 0.179 mm. In the multicore cable 40 of the experimental example 4-2, the insulated wire located on the outer peripheral side of the core was in direct contact with the outer sheath. In addition, it was confirmed that in the multicore cable 40 of the experimental example 4-2, the resin of the outer sheath does not penetrate into the inside of the core, and that the void 430 is formed.

It was also confirmed that when the multicore cable 40 of the experimental example 4-2 is bent, the insulated wire disposed on the outer peripheral side of the core and the convex portion are at least partially in contact with each other at the bent portion.

In one cross section perpendicular to the longitudinal direction of the multicore cable of the experimental example 4-2, the number of gaps 14 in which the distance L11 between the adjacent insulated wires disposed on the outer peripheral side of the core 43 is greater than or equal to 0.01 mm, and the minimum value and the maximum value of the distance L11, were measured. The distance between the adjacent insulated wires refers to the distance between the insulated wires 11, and the distance between the circumcircle 31C of the twisted pair insulated wire 31 and the insulated wire 11. The measured results are illustrated in Table 4.

When the noise test described above was performed on the multicore cables of the experimental examples 4-1 and 4-2, the generation of the noise was confirmed in the experimental example 4-1. In contrast, no generation of the noise was observed in the multicore cable of the experimental example 4-2.

### Experimental Example 5

Multicore cables of the following experimental examples 5-1 and 5-2 were manufactured. The experimental example 5-1 is a comparative example, and the experimental example 5-2 is an exemplary implementation.

In the experimental example 5-1 and the experimental example 5-2, the multicore cables were manufactured so that the configuration of the core becomes the same as the configuration of the core 53 of the multicore cable 50 illustrated in FIG. 5 in the cross section perpendicular to the longitudinal direction.

The specifications of the manufactured multicore cables are summarized in Table 5.

In the experimental example 5-1, the outer sheath was formed on the outer periphery of the core by pipe extrusion. In the experimental example 5-2, the outer sheath 12 was formed by solid extrusion, so as to cover the outer surface 53A of the core 53.

TABLE 5

| | | | | | Twisted pair |
|---|---|---|---|---|---|
| | | | | Insulated wire (A) | insulated wire (C) |
| Insulated | Central | Material | — | Tin plated annealed | Tin plated annealed |
| wire | conductor | | | copper wire | copper wire |
| | | Configuration | Conductors/mm | 20/0.05 | 20/0.05 |
| | | Outer diameter | mm | 0.26 | 0.26 |
| | Insulator | Material | — | ETFE | ETFE |
| | | Thickness | mm | 0.06 | 0.08 |
| | | Outer diameter | mm | 0.38 | 0.38 |
| | Twisting | Configuration | — | — | 2C |
| | | Twist pitch | mm | — | 9 |

| Aggregate (core) | Configuration | | — | (A) × 15 + (C) × 2 |
|---|---|---|---|---|
| | Twist pitch | | mm | 35 |
| | Gap of | Number | Location | 11 |
| | 0.01 mm | Minimum | mm | 0.01 |
| | or greater | value | | |
| | | Maximum | mm | 0.20 |
| | | value | | |

| Outer sheath | Material | — | PVC |
|---|---|---|---|
| | Thickness | mm | 0.37 |
| | Outer diameter | mm | 2.8 |

In the multicore cable of the experimental example 5-1, similar to the experimental example 1-1 and the experimental example 1-2, the outer sheath did not include the convex portion 121.

In contrast, in the multicore cable of the experimental example 5-2, it was confirmed that the outer sheath 12 includes the convex portion 121, the insulated wire 11 and the convex portion 121 are in close contact with each other, and the insulated wire 11 and the convex portion 121 are in direct contact with each other. The minimum value of the height of the convex portion was 0.077 mm, and the maximum value of the height was 0.132 mm. In the multicore cable 50 of the experimental example 5-2, the insulated wire located on the outer peripheral side of the core was in direct contact with the outer sheath. In addition, it was confirmed that in the multicore cable 50 of the experimental example 5-2, the resin of the outer sheath does not penetrate into the inside of the core, and that the void 530 is formed.

It was also confirmed that when the multicore cable 50 of the experimental example 5-2 is bent, the insulated wire disposed on the outer peripheral side of the core and the convex portion are at least partially in contact with each other at the bent portion.

In one cross section perpendicular to the longitudinal direction of the multicore cable of the experimental example 5-2, the number of gaps 14 in which the distance L11 between the adjacent insulated wires disposed on the outer peripheral side of the core 53 is greater than or equal to 0.01 mm, and the minimum value and the maximum value of the distance L11, were measured. The distance between the adjacent insulated wires refers to the distance between the insulated wires 11, and the distance between the circumcircle 31C of the twisted pair insulated wire 31 and the insulated wire 11. The measured results are illustrated in Table 5.

When the noise test described above was performed on the multicore cables of the experimental examples 5-1 and 5-2, the generation of the noise was confirmed in the experimental example 5-1. In contrast, no generation of the noise was observed in the multicore cable of the experimental example 5-2.

### DESCRIPTION OF REFERENCE NUMERALS

10, 20, 30, 40, 50: Multicore cable
11, 11A-11D: Insulated wire (first insulated wire)
D11: Outer diameter of first insulated wire
21: Second insulated wire
D21: Outer diameter of second insulated wire
31: Twisted pair insulated wire
311: Insulated wire
31C: Circumcircle
111, 211, 3111: Central conductor
112, 212, 3112: Insulator
12: Outer sheath
121: Convex portion
H121: Height of convex portion
L11: Distance between insulated wires located on outer peripheral side of core
13, 23, 33, 43, 53: Core
13A, 23A, 33A, 43A, 53A: Outer surface of core
130, 230, 330, 430, 530: Void
14: Gap
A: Left right arrow
231: First region
232: Second region
34: Inclusion
L1, L31: Common tangent
L2, L32: Straight line
600: Multicore cable before bending
601: Multicore cable after bending

1. A multicore cable comprising:
a core including a plurality of insulated wires; and
an outer sheath covering an outer surface of the core,
wherein the outer sheath includes a convex portion disposed between a pair of adjacent insulated wires among the plurality of insulated wires located on an outer peripheral side of the core and in contact with at least a portion of surfaces of the pair of adjacent insulated wires.

2. The multicore cable as claimed in claim 1, wherein a height of the convex portion is greater than or equal to 0.05 mm.

3. The multicore cable as claimed in claim 1, wherein
the plurality of insulated wires include a first insulated wire, and a second insulated wire having an outer diameter larger than an outer diameter of the first insulated wire, and
the second insulated wire is disposed on the outer peripheral side of the core.

4. The multicore cable as claimed in claim 3, wherein
the first insulated wire and the second insulated wire are disposed on the outer peripheral side of the core, and
in a cross section perpendicular to a longitudinal direction of the core, a first region including the first insulated wire and a second region including the second insulated wire are alternately arranged along an outer periphery of the core.

5. The multicore cable as claimed in claim 1, wherein the core includes a twisted pair insulated wire having two insulated wires twisted together.

6. The multicore cable as claimed in claim 1, wherein the insulated wire located on the outer peripheral side of the core is in direct contact with the outer sheath.

7. The multicore cable as claimed in claim 1, wherein at least a portion of the insulated wire disposed on the outer peripheral side of the core and the convex portion are in contact with each other at a bent portion of the multicore cable in a state where the multicore cable is bent at the bent portion.

8. The multicore cable as claimed in claim 1, wherein
the insulated wire includes a central conductor, and an insulator covering an outer surface of the central conductor, and
the insulator includes a fluororesin.

9. The multicore cable as claimed in claim 1, wherein the outer sheath includes a thermoplastic resin.

10. The multicore cable as claimed in claim 1, wherein the core has a gap between at least the pair of adjacent insulated wires among the plurality of insulated wires located on the outer peripheral side of the core.

11. The multicore cable as claimed in claim 1, wherein a void is provided inside the core in a cross section perpendicular to a longitudinal direction.
